(19) United States
(12) Patent Application Publication
(10) Pub. No.: US 2015/0193093 A1
(43) Pub. Date: Jul. 9, 2015

(54) METHOD AND SYSTEM FOR A HEAD UNIT APPLICATION HOST

(71) Applicant: Ford Global Technologies, LLC, Dearborn, MI (US)

(72) Inventors: Joey Ray GROVER, Madison Heights, MI (US); Joel FISCHER, Royal Oak, MI (US); Justin DICKOW, Royal Oak, MI (US); Scott SMEREKA, Warren, MI (US); Philip Joseph DANNE, Royal Oak, MI (US)

(73) Assignee: Ford Global Technologies, LLC, Dearborn, MI (US)

(21) Appl. No.: 14/148,036

(22) Filed: Jan. 6, 2014

(51) Int. Cl. G06F 3/0482; G06F 3/0488; H04L 29/08; G06F 3/0481

(52) U.S. Cl. CPC G06F 3/0482; G06F 3/04817; G06F 3/0488; H04L 67/10

(57) ABSTRACT

One embodiment includes a system having a user interface display and at least one controller in communication with one or more transceivers. The one or more transceivers are capable of communication with one or more devices. The at least one controller is configured to receive a request to communicate with the one or more devices. The controller is further configured to establish communication with the one or more devices. The controller is further configured to transmit a request for an application list compatible with the head unit from the one or more devices based on the head unit system. The controller is further configured to receive the application list from the one or more devices and output the application list at the user interface display. The output of the application list at the user interface display includes at least one icon.

### TECHNICAL FIELD

The present disclosure generally relates to vehicle infotainment systems, and more particularly, to systems and methods using applications on mobile devices in infotainment systems.

### BACKGROUND

U.S. Pat. No. 8,346,310 generally discloses a vehicle-based computing apparatus including a computer processor in communication with persistent and non-persistent memory. The apparatus also includes a local wireless transceiver in communication with the computer processor and configured to communicate wirelessly with a wireless device located at the vehicle. The processor is operable to receive, through the wireless transceiver, a connection request sent from a nomadic wireless device, the connection request including at least a name of an application seeking to communicate with the processor. The processor is further operable to receive at least one secondary communication from the nomadic device, once the connection request has been processed. The secondary communication is at least one of a speak alert command, a display text command, a create phrase command, and a prompt and listen command.

U.S. Patent Application 2013/0053003 generally discloses an auxiliary device and system for adding web-based multimedia applications onto a multimedia device through a user's mobile phone. The auxiliary device and system include a housing in electrical communication with the multimedia device. The housing has a processor operable to execute a first application. The first application is operable to access the Internet through the user's mobile phone. The first application includes a list of predetermined numbers of websites. An input is operable to select at least one of a plurality of websites and transmit the data from the website onto the multimedia device.

U.S. Patent Application 2013/0138728 generally discloses a mobile device, a display device and a method for controlling the same are disclosed. The mobile device for performing data communication with a display device includes a display module configured to display a current screen including at least one object, a transmission module configured to transmit an image corresponding to the current screen to the display device if mirroring connection with the display device is established, a reception module configured to receive at least one command for controlling a specific object from the display device, and a controller configured to execute the specific object based on the received at least one command.

### SUMMARY

In a first illustrative embodiment, a system including a user interface display and at least one controller in communication with one or more transceivers. The one or more transceivers are capable of communication with one or more devices. The at least one controller is configured to receive a request to communicate with the one or more devices. The controller is further configured to establish communication with the one or more devices. The controller is further configured to transmit a request for an application list compatible with the at least one controller from the one or more devices. The at least one controller is further configured to receive the application list from the one or more devices and output the application list at the user interface display. The output of the application list at the user interface display includes at least one icon.

In a second illustrative embodiment, a computer-program product embodied in a non-transitory computer read-able medium that is programmed for communicating mobile device application data to one or more controllers for at least one of audio playback and display. The computer-program product comprises instructions for receiving a request to communicate with the one or more devices. The computer-program product comprises additional instructions to establish communication with the one or more devices. The computer-program product comprises additional instructions to transmit a request for an application list compatible with the one or more controllers from the one or more devices. The computer-program product comprises additional instructions to receive the application list from the one or more devices and output the application list at a user interface display, wherein the application list includes at least one icon.

In a third illustrative embodiment, an application management method for communicating mobile application data. The method may receive a controller a request to communicate with one or more devices. The method may establish communication with the one or more devices and transmit a request for an application list compatible with the controller from the one or more devices. The method may receive the application list from the one or more devices and output the application list at a user interface display, wherein the application list includes at least one icon.

### BRIEF DESCRIPTION OF THE DRAWINGS

FIG. 1 is an exemplary block topology of a vehicle infotainment system implementing a user-interactive vehicle information display system according to an embodiment;

FIG. 2 is an exemplary block topology of a system for integrating one or more connected devices with the vehicle based computing system according to an embodiment;

FIG. 3 is a block diagram illustrating a vehicle computing system in communication with one or more connected devices according to an embodiment;

FIG. 4 is a flow chart illustrating an example method of a vehicle computing system managing, displaying, and executing applications received from a device according to an embodiment;

FIG. 5 is a flow chart illustrating an example method of a vehicle computing system communicating with a device according to an embodiment; and

FIG. 6 is a flow chart illustrating an example method of a vehicle computing system communicating with an external source providing applications according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programmed to perform any number of the functions as disclosed.

A vehicle may have a user interface system that may communicate with one or more nomadic devices. The user interface system may include, but is not limited to, a vehicle computing system, a display, and at least one connection apparatus to communicate with one or more nomadic devices. A user may interface with the one or more nomadic devices using the vehicle interface system. The one or more nomadic devices may contain several applications that may be compatible with the interface system for operation of a feature and/or function. The applications may be executed on the nomadic device, system, and/or a combination of both; and the output data may be presented to a user at the interface system.

The one or more nomadic devices communicating with the interface system may experience different management, output, and/or display of content based on the connected nomadic device operating host (e.g., Android, Windows, iOS, etc.). A user of the system may want a user interface paradigm that offers no discernible difference to the user between nomadic devices that are communicating to the system using different operating hosts.

The present disclosure provides a cohesive experience operating the interface system using one or more nomadic devices. No matter the operating system executing the feature/function on the nomadic device, the system may output content in a paradigm that offers no discernible difference to the user between applications that are running on different operating hosts. The operating host may include, but is not limited to, the nomadic device operating system, the vehicle computing system, and/or a remote server.

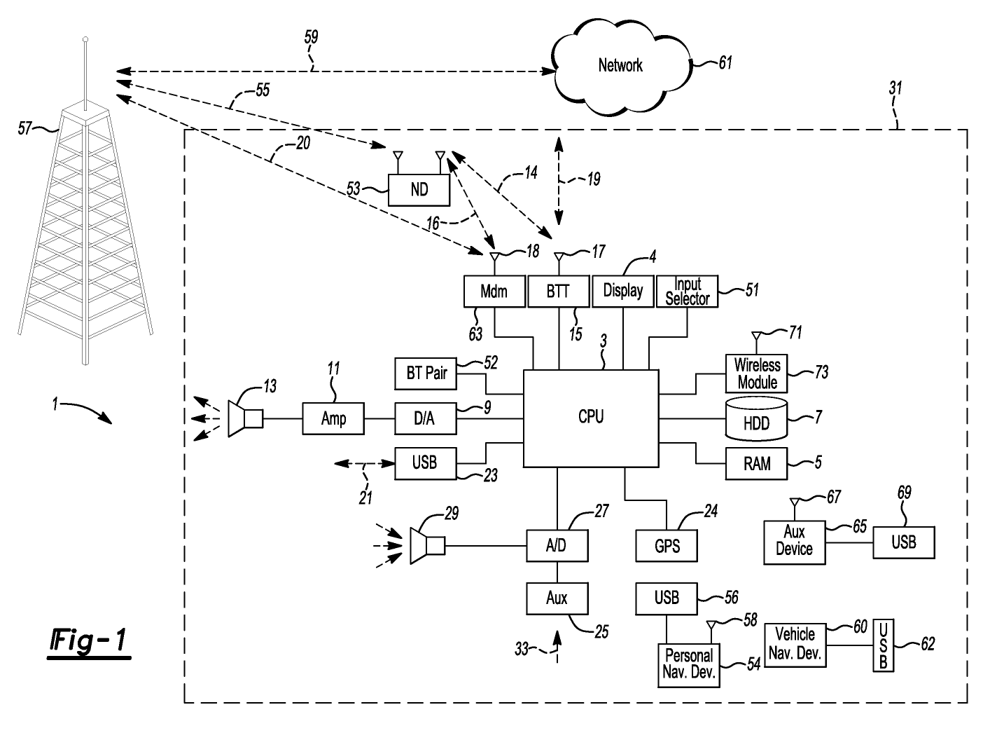

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

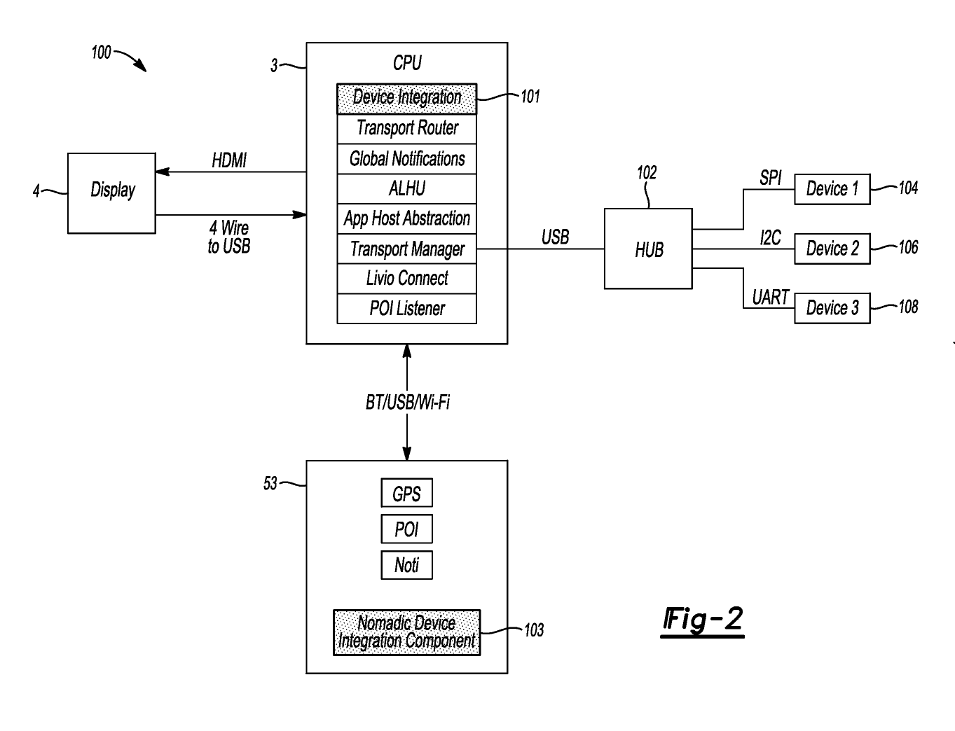

FIG. 2 is an exemplary block topology of a system 100 for integrating one or more connected devices with the vehicle based computing system 1 (VCS). The CPU 3 may be in communication with one or more transceivers. The one or more transceivers are capable for wired and wireless communication for the integration of one or more devices. To facilitate the integration, the CPU 3 may include a device integration framework 101 configured to provide various services to the connected devices. These services may include transport routing of messages between the connected devices and the CPU 3, global notification services to allow connected devices to provide alerts to the user, application launch and management facilities to allow for unified access to applications executed by the CPU 3 and those executed by the connected devices, and point of interest location and management services for various possible vehicle 31 destinations.

As mentioned above, the CPU 3 of the VCS 1 may be configured to interface with one or more nomadic devices 53 of various types. The nomadic device 53 may further include a device integration client component 103 to allow the nomadic device 53 to take advantage of the services provided by the device integration framework 101.

The one or more transceivers may include a multiport connector hub 102. The multiport connector hub 102 may be used to interface between the CPU 3 and additional types of connected devices other than the nomadic devices 53. The multiport connector hub 102 may communicate with the CPU 3 over various buses and protocols, such as via USB, and may further communicate with the connected devices using various other connection buses and protocols, such as Serial Peripheral Interface Bus (SPI), Inter-integrated circuit (I2C), and/or Universal Asynchronous Receiver/Transmitter (UART). The multiport connector hub 102 may further perform communication protocol translation and interworking services between the protocols used by the connected devices and the protocol used between the multiport connector hub 102 and the CPU 3. The connected devices may include, as some non-limiting examples, a radar detector 104, a global position receiver device 106, and a storage device 108.

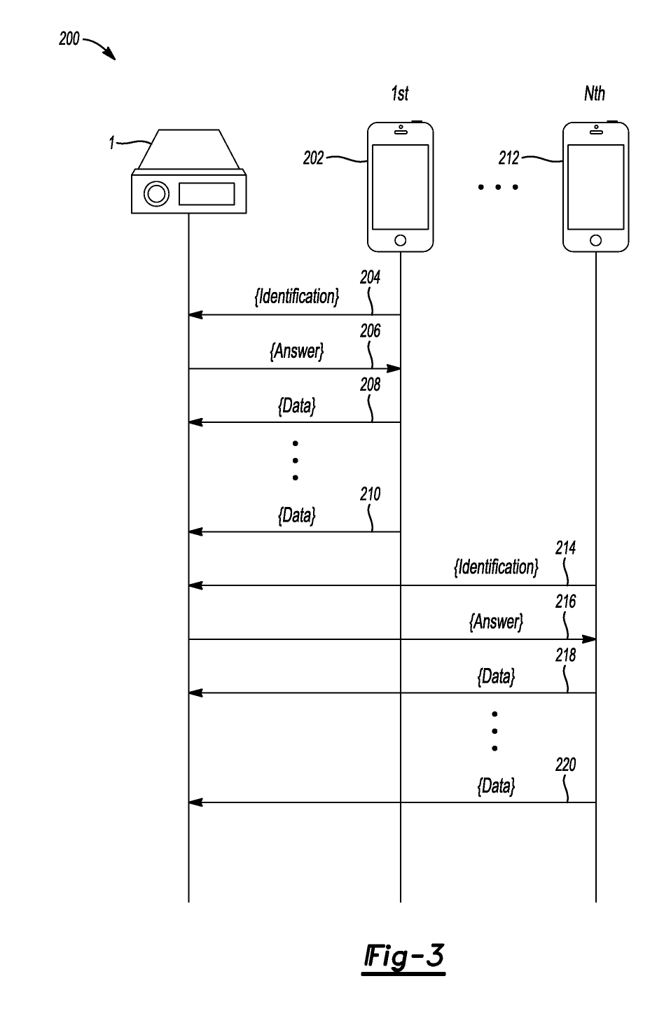

FIG. 3 is a block diagram 200 illustrating the vehicle computing system 1 in communication with one or more devices 202, 212 according to an embodiment. The VCS 1 may receive identification 204, 214 requests from one or more devices 202, 212. The first device 202 may transmit an identification request 204 once the VCS 1 is detected. The identification request 204 may include, but is not limited to, requesting if the first device 202 is compatible with the VCS 1, and if the first device 202 has an application/service that may depend on the device 202.

The VCS 1 may respond to the identification 204 request and transmit an answer 206 to the first device 202. The answer may include, but is not limited to, a message notifying the device 202 is not compatible with the VCS 1, or a message notifying the device 202 is compatible with the VCS 1 and what application(s) and/or services that may be enabled by the VCS 1. Data 208, 210 may be transmitted to the VCS 1 if the first device 202 is compatible with the VCS 1.

The VCS 1 may communicate with several devices. For example, an additional device 212 may transmit an identification request 214 once the VCS 1 is detected. The identification request 214 may include, but is not limited to, requesting if the additional device 212 is combatable with the VCS 1, and if the additional device 212 has an application/service that may depend on the device 212.

The VCS 1 may respond to the identification 214 request and transmit an answer 216 to the additional device 212. The answer may include, but is not limited to, a message notifying the device 212 is not compatible with the VCS 1, or a message notifying the device 212 is compatible with the VCS 1 and what application(s) and/or services that may be enabled by the VCS 1. Data 218, 220 may be transmitted to the VCS 1 if the additional device 212 is compatible with the VCS 1.

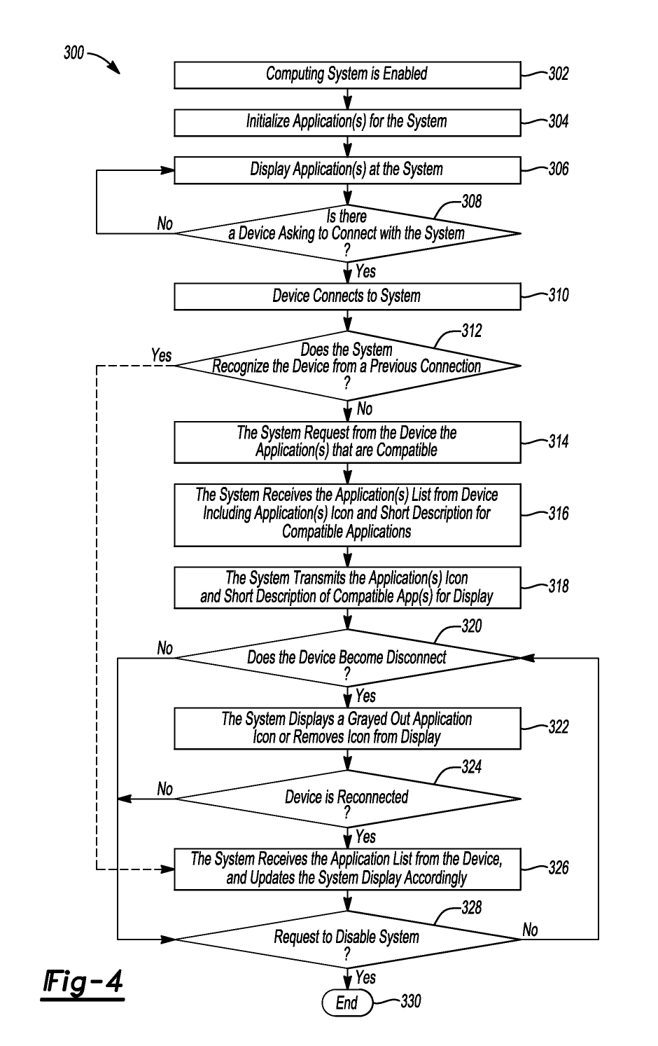

FIG. 4 is a flow chart illustrating an example method 300 of a vehicle computing system (VCS) 1 managing, displaying, and executing applications received from a device. The method 300 may be implemented using software code contained within the VCS 1. In other embodiments, the method 300 may be implemented in other vehicle controllers, or distributed amongst multiple vehicle controllers.

Referring again to FIG. 4, the vehicle and its components illustrated in FIG. 1, FIG. 2, and FIG. 3 are referenced throughout the discussion of the method to facilitate understanding of various aspects of the present disclosure. The method 300 of recognizing compatible feature/function/service applications while communicating with one or more devices may be implemented through a computer algorithm, machine executable code, or software instructions programmed into a suitable programmable logic device(s) of the vehicle, such as the vehicle control module, the device control module, another controller in communication with the vehicle computing system, or a combination thereof. Although the various operations shown in the flowchart diagram 300 appear to occur in a chronological sequence, at least some of the operations may occur in a different order, and some operations may be performed concurrently or not at all.

In operation 302, the VCS 1 may be enabled by a start request received from one or more mechanisms including, but not limited to, a vehicle key, a vehicle key fob, a wireless device, and/or a combination thereof. The VCS 1 may initialize one or more applications for execution in operation 304.

In operation 306, the VCS 1 may output one or more applications at a display 4 in communication with one or more controllers configured within the system. The VCS may store, but choose not to display, one or more applications which require an external data source to be present. The VCS 1 may search for one or more devices 202 requesting to connect with the system in operation 308. If the VCS 1 detects no device asking to connect, the system may continue to output to the display 4 the applications initialized. If a device is detected, the VCS 1 may attempt to connect using a communication link with the device in operation 310. The communication link may include wireless communication technology (e.g., Bluetooth, Bluetooth low energy, WiFi, etc.) and/or a wired connection (e.g., USB, SPI, UART, etc.).

In operation 312, the system may determine if the one or more devices 202 requesting to communicate with the VCS 1 are recognized as previously connected device(s). If the one or more devices 202 are a new connection with the system, the system may request from the device 202 the application(s) that are compatible with the VCS 1 in operation 314. If the one or more devices 202 were previously connected with the system, the VCS 1 may update the display 4 with the previous download compatible applications in operation 326.

In operation 316, the VCS 1 may receive an application list of compatible applications from the one or more devices 202 including application icon(s) and/or a description for the compatible application(s). The VCS 1 may transmit the application(s) icon and/or short description of the compatible application(s) for output at the display 4.

In operation 320, the VCS 1 may continuously monitor to determine if the device 202 becomes disconnected from the system. If the VCS 1 detects that a device 202 has been disconnected from communication with the system, the VCS 1 may output to the display 4 a grayed out application icon or remove the icon(s) from the display 4 in operation 322.

In operation 324, the VCS 1 may monitor if the device 202 is reconnected to the system. If the device is reconnected with the VCS 1, the system may receive the application list form the device 202 and update the display 4 accordingly in operation 326. If the device 202 is not reconnected, the VCS 1 may determine if a system disable request received in operation 328. If the system is not being requested to be disabled, the VCS 1 may continue to monitor the connection of the one or more devices 202 in communication with the system. If a request to disable the VCS 1 is received, the system may store one or more application icons and/or short descriptions in correlation with the respective device 202 in nonvolatile memory in operation 330.

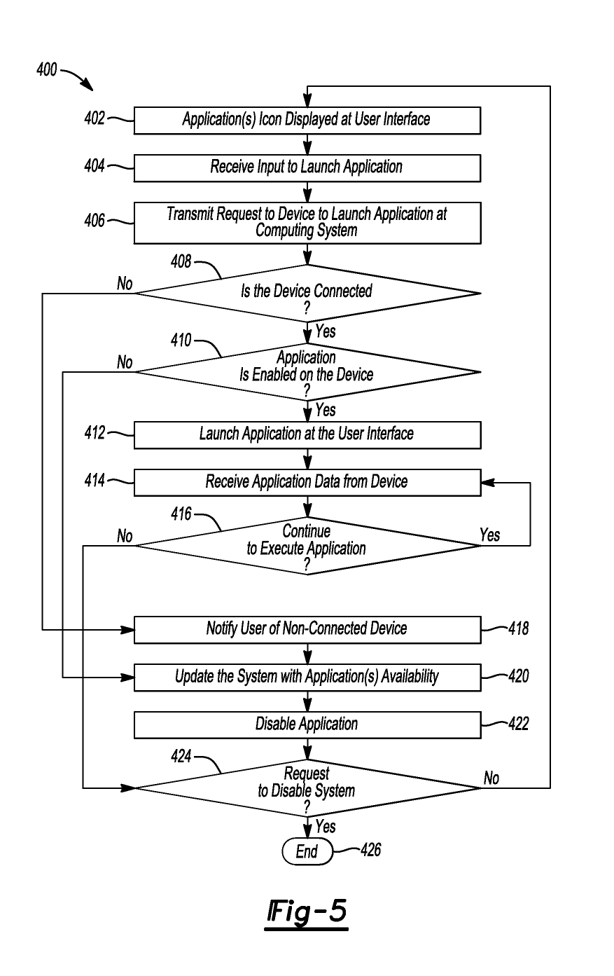

FIG. 5 is a flow chart illustrating an example method 400 of a vehicle computing system (VCS) 1 communicating with a device 202 according to an embodiment. The VCS 1 may have a display 4 that is updated and configured based on communication with the device 202. The device 202 may transmit one or more applications icons and/or short descriptions that are compatible with the VCS 1 to a user interface display 4. The device 202 may include, but is not limited to, smart phone, radar detector, tablet, and/or global position receiver. The VCS 1 may have one or more transceivers capable for wired and/or wireless communication.

In operation 402, the device 202 may transmit to the VCS 1 an application icon for output at the user interface display 4. The user interface display 4 may receive input to launch the application in operation 404.

For example, the user interface display 4 may receive user input such that the VCS 1 may determine that the application is being requested for execution. The user input may include, but is not limited to, received touch from the user at the display 4, a hard button selection configured with the application icon, a voice command input, and/or a combination thereof.

In operation 406, the VCS 1 may transmit a message to the device 202 notifying a request to launch the application. The VCS 1 may determine if the device 202 is connected in operation 408.

In operation 418, if the device 202 is not connected, the VCS 1 may notify the user of the non-connected device 202. For example, the VCS 1 may not be able to launch the application if the device 202 is not connected. The VCS 1 may update the application icon and/or short description at the interface display 4 to notify the user that the application is unavailable in operation 420. For example, the VCS 1 may request a grayed out of the application icon or remove the icon from the display 4 if the application is unavailable.

In operation 410, if the device 202 is connected, the VCS 1 may receive notice that the application is either enabled or disabled at the device 202. If the application is disabled at the device 202, the VCS 1 may update the availability status at the display 4 to notify the user in operation 420. For example, the VCS may update the display 4 to notify the user that the application is unavailable by removing the icon, changing the icon's color such that it is differential form the other displayed icons (e.g., such as graying out the icon), and/or resorting the application icon list such that the unavailable application icon(s) are presented last.

In operation 412, if the device 202 is connected and the application is enabled, the device may transmit the application data such that the application is launched at the VCS 1. The VCS 1 may receive application data from the device 202 in operation 414. The VCS 1 may continue to execute the application unit it receives a request to disable in operation 416.

In operation 422, the request to disable the application being executed at the device 202 may be received at the system display 4. The VCS 1 may transmit a message to notify the device 202 that the application may be disabled. The VCS 1 may determine whether a request to disable the system is being requested in operation 424. If the VCS 1 is being requested to disable, the system may begin to shut down while storing one or more parameters/setting related to the one or more applications in non-volatile memory.

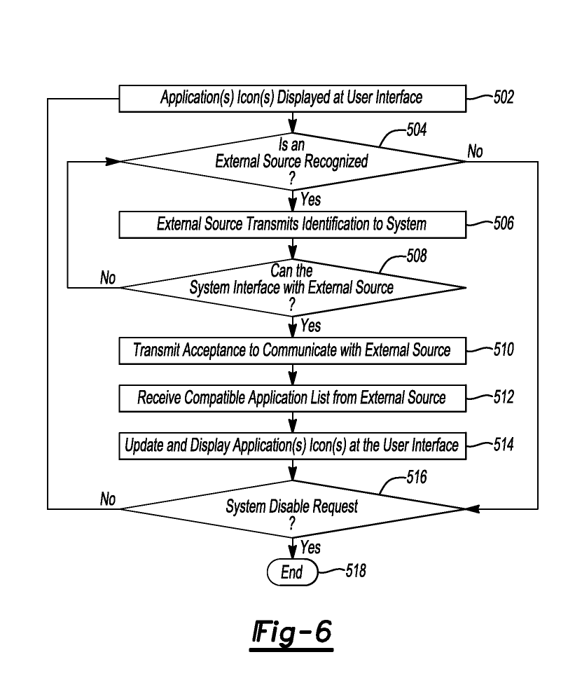

FIG. 6 is a flow chart illustrating an example method 500 of a vehicle computing system (VCS) 1 communicating with an external source providing applications according to an embodiment. The system may continuously receive updated application icons at the user interface display 4 based on one or more external sources connected to the system.

In operation 502, the application icon presented at a user interface display 4 may be configured to notify a user of the applications availability. For example, if the external source supporting an application is no longer connected to the system, the icon may be grayed out. The system may determine if an external source has been detected in operation 504.

In operation 506, if an external source is recognized, the external source may transmit identification to the system providing data based on the one or more applications stored on the source. The system may determine if it may be able to communicate and interface with the external source in operation 508.

In operation 510, if the system is compatible with the external source, the system may transmit an acceptance to communicate with the external source. The system may also transmit with the acceptance additional information with regards to the system including, but not limited to, a system identification number. Based on the system identification number, the external device may generate a list of compatible applications that may be executed with the system.

In operation 512, the system may receive an application list of compatible applications from the external source. The system may update and output the application icon(s) that are compatible with the VCS 1 at the user interface display 4 in operation 514.

In operation 516, the system may monitor to see if a disable request has been requested. If no disable request has been received, the system may continue to display one or more application icons at a user interface display 4 while monitoring if a new external source is trying to communicate with the system.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A system comprising:
at least one controller in communication with one or more transceivers, the one or more transceivers capable of communication with one or more devices, the at least one controller configured to:
receive a request to communicate with the one or more devices;
establish communication with the one or more devices;
transmit a request for an application list compatible with the at least one controller from the one or more devices;
receive the application list from the one or more devices; and
output the application list at a user interface display, wherein the application list includes at least one icon.

2. The system of claim 1, wherein the at least one controller is further configured to:
determine if the one or more devices previously communicated with the controller; and
if previously communicated, update the application list for output to the user interface display.

3. The system of claim 1, wherein the application list includes a description of an application.

4. The system of claim 3, wherein the at least one controller is further configured to:
determine if the one or more devices have disconnected communication with the at least one controller; and
if the one or more devices have disconnected communication, update the application list for output by at least one of removal of the icon and description from the user interface display, or a grayed out icon at the user interface display.

5. The system of claim 4, wherein the at least one controller is further configured to:
determine if the one or more devices have re-established communication with the at least one controller; and
if the one or more devices have re-established communication, update the user interface display to output the icon and description or remove the grayed out icon with a display of the icon.

6. The system of claim 1, wherein the one or more transceivers are capable of wireless communication and wired communication.

7. The system of claim 6, wherein the wireless communication includes at least one of Bluetooth, Bluetooth low energy, Near Field Communication, and WiFi.

8. The system of claim 6, wherein the wired communication includes at least one of Serial Peripheral Interface Bus, Inter-integrated circuit, and Universal Asynchronous Receiver/Transmitter.

9. The system of claim 1, wherein the user interface display is a touch screen liquid crystal display.

10. A computer-program product embodied in a non-transitory computer readable medium that is programmed for communicating mobile device application data to one or more controllers for at least one of audio playback and display, the computer-program product comprising instructions for:
receiving a request to communicate with the one or more devices;
establishing communication with the one or more devices;
transmitting a request for an application list compatible with the one or more controllers from the one or more devices;
receiving the application list from the one or more devices; and
outputting the application list at a user interface display, wherein the application list includes at least one icon.

11. The computer-program product of claim 10, wherein the application list includes a description of an application.

12. The computer-program product of claim 11, further comprising additional instructions to:
determining if the one or more devices have disconnected communication with the one or more controllers; and
if the one or more devices have disconnected communication, updating the application list for output by at least one of removal of the icon and description from the user interface display, or grayed out the icon at the user interface display.

13. The computer-program product of claim 12, further comprising additional instructions to:
determining if the one or more devices have re-established communication with the one or more controllers; and
if the one or more devices have re-established communication, updating the user interface display to output the icon and description or remove the grayed out icon with a display of the icon.

14. The computer-program product of claim 10, wherein the communication with the one or more devices includes wireless and wired technology.

15. A application management method comprising:
receiving at a controller a request to communicate with one or more devices;
establishing communication with the one or more devices;
transmitting a request for an application list compatible with the controller from the one or more devices;
receiving the application list from the one or more devices; and
outputting the application list at a user interface display, wherein the application list includes at least one icon.

16. The method of claim 15, wherein the application list includes a description of an application.

17. The method of claim 16, further comprising:
determining if the one or more devices have disconnected communication with the controller; and
if the one or more devices have disconnected communication, updating the application list for output by at least one of removal of the icon and description from the user interface display, or grayed out the icon at the user interface display.

18. The method of claim 17, further comprising:
determining if the one or more devices have re-established communication with the at the controller; and
if the one or more devices have re-established communication, updating the user interface display to output the icon and description or remove the grayed out icon with a display of the icon.

19. The method of claim 15, wherein the communication is enabled using one or more transceivers configured with the user interface display.

20. The method of claim 19, wherein the one or more transceivers are capable of wireless communication and wired communication.
